(19) United States
(12) Patent Application Publication
(10) Pub. No.: US 2008/0172637 A1
(43) Pub. Date: Jul. 17, 2008

(54) METHOD AND SYSTEM FOR USING IMAGE GLOBALIZATION IN DYNAMIC TEXT GENERATION AND MANIPULATION

(75) Inventors: Belinda Ying-Chieh Chang, Cary, NC (US); Vijay Dheap, Durham, NC (US)

Correspondence Address: GERALD J. IWANEJKO, JR., 229 HICKORY HILL DRIVE, VOLANT, PA, 16156, US

(73) Assignee: INTERNATIONAL BUSINESS MACHINES CORPORATION, Armonk, NY (US)

(21) Appl. No.: 11/623,213

(22) Filed: Jan. 15, 2007

(51) Int. Cl. G06F 3/048

(52) U.S. Cl. 715/846

(57) ABSTRACT

An invention is disclosed for achieving “image globalization” through dynamic text generation and manipulation by independently translating textual elements within a graphic image into different languages (or other domains of use). This concept can be used in creating multiple text-containing graphic images (each customized for a specific domain of use) from an initial template or master image of any type.

### TECHNICAL FIELD

This invention relates to a technique for achieving “image globalization” through dynamic text generation and manipulation.

### BACKGROUND

Computer software product documentation and self-help resources often omit useful text-containing graphic images when they are required to be translated into multiple languages, because the labor intensive process for translating the associated text into each language is cost-prohibitive and time-consuming, since it requires manually editing or re-creating the image every time that it is translated into a different language. On the other hand, providing only textual descriptions has drawbacks since it usually requires more words to convey a precise message than with the assistance of a graphic image, and since the use of natural language involves inherent ambiguities that can lead to misunderstandings.

This invention addresses current limitations related to inclusion of graphic images in translated documentation, by providing a method and system for use of “image globalization” to enable translation of textual elements within a graphic image. Such a dynamic image text generation and manipulation program can be offered as a solution for customization of text-containing graphic images through translation into specific language domains. Although language translation is described herein, the same concepts can be used in creating multiple text-containing graphic images from an initial template or master image of any type, each customized for a specific domain of use.

### SUMMARY OF THE INVENTION

An invention is disclosed for achieving “image globalization” through dynamic text generation and manipulation by independently translating textual elements within a graphic image into different languages (or other domains of use). This concept can be used in creating multiple text-containing graphic images (each customized for a specific domain of use) from an initial template or master image of any type.

Specifically, the invention provides a computer processing method and system for “globalizing” documentation by extracting textual information contained within a graphic image for independent translation into different languages or other domains of use. To accomplish this, each image region in which textual element(s) appear is separately “annotated” by providing it with a unique identification code (or “key”) that is linked (or “mapped”) to the original text presented in the image. The image text is then translated into each desired language with the same manual and/or computer processing techniques used for translating other textual documentation, and the region identification code “key(s)” are then matched to place (or “transpose”) the translated text back onto the original image to generate text-containing graphic image(s) written in each translated language.

It is therefore an object of the present invention to overcome the disadvantages of the prior art by providing a computer processing method and system for independently translating textual elements within a graphic image to create one or more additional text-containing graphic images which are each a customized version of the original graphic image adapted for a specific language or other domain of use.

The subject matter which is regarded as the invention is particularly pointed out and distinctly claimed in the concluding portion of the specification. The invention, however, together with further objects and advantages thereof, may best be understood by reference to the following description taken in conjunction with the accompanying drawings.

### BRIEF DESCRIPTION OF THE DETAILED DRAWINGS

FIG. 1 illustrates an image editing program that outputs combined graphic/textual content.

### DETAILED DESCRIPTION OF THE PREFERRED EMBODIMENTS

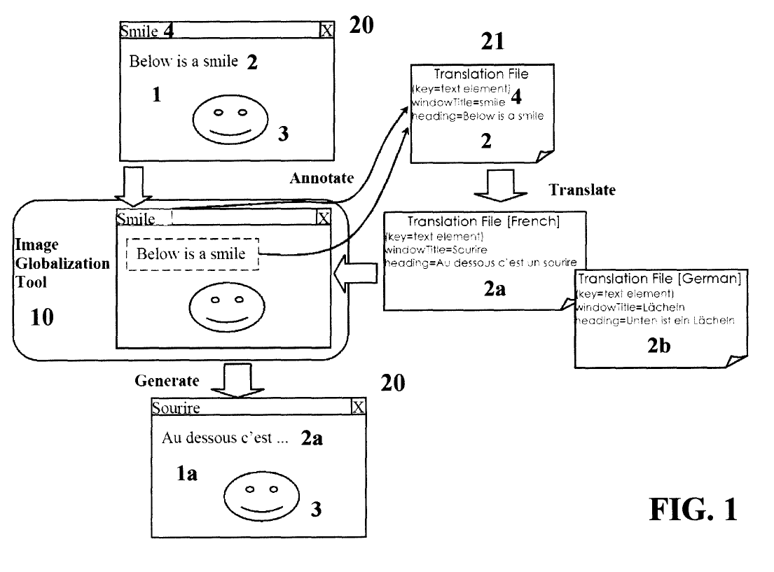

As shown in FIG. 1, implementation of the invention involves capturing the original graphic image 1 by electronically loading it into an image editor 10 functioning as a “globalization tool” with the capability of uniquely identifying textual 2 and/or graphic 3 region(s) within the image, such as the Adobe Photoshop® software system.

The image editor 10 enables a user to specify preferences in how the translated text strings 2a and/or 2b are displayed in a (preferably graphical) user interface (GUI) 20 (i.e., font, size, color, etc.) or to alternately set automatic defaults for such features, and it is also capable of inserting (or “importing”) translated textual data to automatically generate graphic images containing this information. The image editor can also identify natural language “breaks” to process a translated textual element that does not fit within its predefined image region; i.e., if a translated text string is too large in size to fit within its image region, then a natural language “break-point” can be identified for appending a program construct that identifies the additional text elements (using such features as footnotes or “meta-tags”, etc.) The image editor 10 also provides the capability of extracting (or “exporting”) a translated text-containing graphic image 1a (in a user-specified format) and any associated code (written in a language such as hypertext markup language (HTML) or javascript) for inclusion with other textual documentation.

The example depicted in FIG. 1 illustrates an image editing program 10 that is used to access combined graphic/textual content 1 contained in a GUI window 20 running any program that utilizes such content. The image editing program 10 uses a “properties” file 21 such as a natural language support (“NLS”) file for storing the textual data elements 2 presented in the window 20, in order to allow these elements to be converted into any desired language using localized manual translation techniques or by use of conventional language translation software such as Google Language Tools®. Such a translation can be carried out by using a “screen capture” from the GUI window 20 to load the image 1 into the editing software 10. Each graphics image containing a textual element 1 is separately identified by specifying unique identification code(s) (or a “key”) 4 for a graphics region 3 which corresponds to the key contained in the properties file 21 for its associated textual element 2. The user selects the preferences for displaying the translated text elements 2a and/or 2b, and the original graphic image 3 is copied with the translated text elements 2a transposed onto the copy 1a. This process is repeated to generate any desired number of copies of the translated text-containing graphic image into all of the languages supported by the translation software system(s).

While certain preferred features of the invention have been shown by way of illustration, many modifications and changes can be made that fall within the true spirit of the invention as embodied in the following claims, which are to be interpreted as broadly as the law permits to cover the full scope of the invention, including all equivalents thereto.

What is claimed is:

1. A computer processing system for translating textual elements contained within a graphic image to create one or more additional text-containing graphic images each customized for a specific language or other domain of use, comprised of at least the following components:
(a). an image editor for electronically capturing one or more graphic images to identify at least one textual or graphic region contained within an image;
(b). at least one data file storing one or more unique identification codes for a graphic image containing textual elements to link each region of identified text with its corresponding graphic region;
(c). a processing means for translating the identified text to generate one or more text-containing graphic images by placing the translated text with its corresponding graphic region using an identification code match;
wherein textual information contained within a graphic image is extracted for independent translation into one or more languages or other domains of use.

2. The computer processing system of claim 1 wherein the image editor inserts translated textual data to automatically generate a text-containing graphic image.

3. The computer processing system of claim 1 wherein the image editor extracts a translated text-containing graphic image and associated program code for inclusion with other textual documentation in a user-specified format.

4. The computer processing system of claim 1 wherein textual elements are translated using localized manual techniques.

5. The computer processing system of claim 1 wherein textual elements are translated using language translation software.

6. The computer processing system of claim 1 wherein the image editor identifies language breakpoints to process a translated textual element that does not fit within its image region.

7. The computer processing system of claim 1 wherein the image editor provides features for a user to specify or to alternately set defaults for preferences in displaying translated text within a graphical user interface.

8. A method of using a computer processing system for translating textual elements contained within a graphic image to create one or more additional text-containing graphic images each customized for a specific language or other domain of use, comprised of at least the following steps:
(a). using an image editor for electronically capturing one or more graphic images to identify at least one textual or graphic region contained within an image;
(b). creating at least one data file storing one or more unique identification codes for a graphic image containing textual elements to link each region of identified text with its corresponding graphic region;
(c). employing a processing means for translating the identified text to generate one or more text-containing graphic images by placing the translated text with its corresponding graphic region using an identification code match;
wherein textual information contained within a graphic image is extracted for independent translation into one or more languages or other domains of use.

9. The method of claim 8 wherein the image editor inserts translated textual data to automatically generate a text-containing graphic image.

10. The method of claim 8 wherein the image editor extracts a translated text-containing graphic image and associated program code for inclusion with other textual documentation in a user-specified format.

11. The method of claim 8 wherein textual elements are translated using localized manual techniques.

12. The method of claim 8 wherein textual elements are translated using language translation software.

13. The method of claim 8 wherein the image editor identifies language breakpoints to process a translated textual element that does not fit within its image region.

14. The method of claim 8 wherein the image editor provides features for a user to specify or to alternately set defaults for preferences in displaying translated text within a graphical user interface.
